(19) United States
(12) Patent Application Publication
(10) Pub. No.: US 2026/0220297 A1
(43) Pub. Date: Jul. 30, 2026

(54) ARTIFICIAL INTELLIGENCE LINEAGE SYSTEM WITH VERIFIABLE INTEGRITY

(71) Applicant: Eric Charran, Doylestown, PA (US)

(72) Inventor: Eric Charran, Doylestown, PA (US)

(21) Appl. No.: 19/574,184

(22) Filed: Mar. 20, 2026

Related U.S. Application Data
(63) Continuation-in-part of application No. 19/272,574, filed on Jul. 17, 2025.
(60) Provisional application No. 63/672,491, filed on Jul. 17, 2024.

(51) Int. Cl. G06F 21/62; G06F 21/53; G06F 21/60; G06N 3/04; H04L 9/00

(52) U.S. Cl. CPC G06F 21/6227; G06F 21/53; G06F 21/602; G06N 3/04; H04L 9/50

(57) ABSTRACT

A system and method for managing artificial intelligence (AI) lineage through a generalized system of record that captures, preserves, and verifies lineage events across the lifecycle of data, datasets, metadata, models, inference outputs, and imprints. The system provides governance functions—including compliance, auditing, and analysis—based on verifiable lineage records. Verifiable integrity may be achieved by one or more mechanisms such as access control with auditability, detection of unauthorized modification, tamper-evidence, cryptographic attestation, or their equivalents. The recordkeeping substrate is technology-agnostic and may be implemented via distributed ledgers, append-only datastores, WORM (Write Once-Read Many) storage, trusted execution environments (TEEs), secure enclaves, or combinations thereof. The system supports centralized and decentralized training environments (including federated learning), cross-platform interoperability, and both retrospective and predictive lineage impact analysis.

### CROSS REFERENCE TO RELATED APPLICATIONS

This application claims priority from a U.S. Patent Appl. No. 19/272,574, filed on 07/17/2025, which claims priority from a U.S. Provisional Patent Appl. No. 63/672,491, filed on 07/17/2024, both of which are incorporated herein by reference in their entirety.

### FIELD OF INVENTION

The present invention relates generally to systems and methods for artificial intelligence (AI) governance, traceability, and compliance. More particularly, the invention pertains to technology-agnostic systems of record configured to capture, preserve, and verify AI lineage events associated with data, datasets, metadata, AI models, training activities, inference outputs, and derivative imprints. The invention further concerns governance functions including regulatory and contractual compliance, auditing, provenance verification, impact assessment, and integrity analysis for AI systems deployed across diverse platforms and lifecycle stages.

### BACKGROUND

In recent years, artificial intelligence (AI) and machine learning (ML) have become integral to a wide range of industries, driving innovation, automation, and operational efficiency. Despite this proliferation, significant challenges persist in tracing the provenance and transformation of datasets and AI models, verifying the integrity of training and inference processes, and ensuring full auditability and transparency across AI development and deployment workflows. Existing AI systems frequently operate as opaque pipelines in which data lineage, model lineage, and inferential logic are neither persistently nor verifiably recorded, making it difficult to validate model outcomes, confirm lawful and ethical use, and demonstrate compliance with data governance, privacy, and safety regulations.

Traditional record-keeping and monitoring techniques lack the technical ability to provide comprehensive, immutable tracking of lineage events across the AI lifecycle. Current logging mechanisms are fragmented, subject to manipulation, and are incapable of maintaining a verifiable history of dataset transformations, model updates, derivative branches, inference outputs, and post-deployment modifications. Such limitations hinder anomaly detection, accountability, and regulatory attestation, particularly in high-stakes applications such as healthcare, finance, security, and public infrastructure. As AI becomes increasingly embedded in consumer and industrial digital ecosystems, new mechanisms are required to support end-to-end verifiability, public trust, and compliance with emerging legal and ethical oversight frameworks.

As used herein, the term “recordkeeping substrate” refers to any storage system or combination of storage systems configured to persist lineage events or derived lineage records in a manner that enables subsequent verification of integrity. A recordkeeping substrate ensures that stored lineage data cannot be altered, deleted, or concealed without detection. Examples of recordkeeping substrates include, but are not limited to, Distributed Ledgers, Append-Only Logs, Write-Once-Read-Many (WORM) storage, Trusted Execution Environments or Secure Enclave Systems that emit attested logs, cryptographically verifiable log structures, hardware-rooted secure storage mechanisms, and combinations thereof. A recordkeeping substrate may be local, cloud-based, federated, decentralized, or hybrid, provided that it is capable of persisting lineage information with integrity guarantees and supporting later validation, auditing, or compliance processes.

As used herein, the term “governance” encompasses activities and processes relating to compliance, auditing, monitoring, and/or analytical review of AI lifecycle artifacts, including validation of adherence to regulatory, contractual, ethical, and operational requirements. It is to be noted that policy enforcement by the governance and analysis module is an optional but supported embodiment.

The term “interface” encompasses visualization, querying, reporting, alerting, and/or any equivalent access mechanism through which lineage information, governance information, or system status may be accessed, rendered, or interacted with by a user or automated agent.

As used herein, the term “verifiable integrity” means that a record or set of records is preserved in such a manner that an authorized observer can determine whether any unauthorized modification, deletion, insertion, or re-ordering of such records has occurred. Verifiable integrity may be achieved by mechanisms including, but not limited to, tamper-evident data structures, detection of unauthorized modification attempts, cryptographic attestation or digital signatures, secure hashing and chain-linking of records, and access-controlled storage with audited and non-repudiable logging. In certain embodiments, verifiable integrity further includes the ability to trace the provenance of record formation and the identity or role of actors associated with lineage events. In certain embodiments, verifiable integrity can be maintained even when the underlying storage system is mutable, as long as unauthorized modification is detectable or attestable.

Any reference to a “lineage graph” or “graph database” herein refers to a representation of lineage information that expresses relationships or connectivity among lineage objects. Such lineage representations may comprise, without limitation, a graph structure, relational schema, key-value index, JSON or document store, columnar mapping, tuple store, semantic triple store, or any equivalent data organization capable of encoding parent–child, predecessor–successor, dependency, or derivation relationships among lineage objects. A lineage graph may be centralized, distributed, federated, or hybrid, and may be implemented logically or physically independent of the underlying recordkeeping substrate. It is to be noted that lineage representation may also maintain temporal ordering of lineage events. Also, the lineage representation supports both backward traversal (from an inference back to its contributing artifacts) and forward traversal (from a change forward to dependent artifacts).

As used herein, the term “integrity-verifiable recordkeeping substrate” refers to any recordkeeping substrate that provides verifiable integrity for persisted lineage information. Examples of integrity-verifiable recordkeeping substrates include, without limitation, distributed ledgers, append-only logs, write-once-read-many (WORM) storage, trusted execution environments or secure enclaves that emit attested logs, and cryptographically verifiable log structures. An integrity-verifiable recordkeeping substrate may be implemented locally, remotely, in a cloud environment, within a decentralized or federated topology, or in any hybrid deployment, provided that it supports detection of unauthorized modification, deletion, concealment, or re-ordering of lineage records. The terms verifiable integrity and integrity-verifiable are used interchangeably herein.

As used herein, the terms “immutable,” “immutability,” and “immutable records” refer to records preserved with verifiable integrity. Immutability, as used in this disclosure, encompasses not only the general understanding of “unchangeable over time,” but also systems that are tamper-evident, detect unauthorized modification attempts, and/or provide cryptographic attestation, signatures, or equivalent mechanisms to ensure that any alteration, insertion, deletion, or re-ordering of records is either technically prevented or detectably revealed. Accordingly, the scope of immutability as used herein is not limited to absolute physical permanence but includes all embodiments in which the integrity of a record can be verified by an authorized observer.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

A principal object of the present invention is to provide a secure, traceable, verifiable, and auditable AI lineage platform employing a multilayered integrity-verifiable framework, featuring federated learning compatibility, anomaly detection, and compliance enforcement mechanisms.

It is another object of the invention to ensure that all authorized actions within the system are verifiable, reproducible, and compliant with predefined lineage policies, while maintaining interoperability across heterogeneous AI development workflows, models, tools, and deployment platforms.

It is a further object of the invention to enhance accountability and transparency in the development and deployment of AI models by recording, preserving, and exposing lineage-related events, transformations, decisions, and model and data derivations.

It is another object of the invention to support real-time responsiveness through the application of integrity-verifiable mechanisms, which may include, as one embodiment, trust mechanisms based on Blockchain or Distributed Ledger Technologies.

In one aspect, the invention provides a system based on verifiable lineage integrity mechanisms that records an integrity-verifiable history of AI system behavior over time. The system supports verification of data and model lineage, detection of manipulation attempts through monitoring of changes in model parameters and data fingerprints, and identification of anomalous events. Each anomaly, transaction, or significant event results in the creation of a new versioned record, forming a verifiable integrity audit trail.

In another aspect, the invention provides a dynamic Anomaly Detection and Correction Engine and a multilayer verifiable integrity architecture in which lineage-critical data is organized by type (e.g., operational events, inference telemetry, anomaly and correction logs, compliance artifacts). The system is compatible with federated learning environments, supports smart-contract-based enforcement of lineage governance policies across distributed systems, provides adaptive role-based interfaces for lineage visualization and interrogation, and implements secure hash-based attestation and provenance tracking (e.g., using SHA-256 and Merkle tree structures). The system further enables real-time alerting, correction logging, and end-to-end system state verification.

In another aspect, the system may be embodied using trust mechanisms based on Blockchain or Distributed Ledger Technologies to implement the multilayer integrity architecture described above, including smart contract execution, cryptographically linked event chains, and decentralized enforcement of governance policies across stakeholders or federated environments.

In another aspect, the invention provides a system that captures lineage events and preserves them as integrity-verifiable records for governance. Lineage events may include metadata, datasets, models, model checkpoints, inference outputs, and derivative imprints such as hashes or digital fingerprints. Verifiable integrity may be ensured by integrity-verifiable storage, cryptographic attestation, auditability controls, or functional equivalents. A governance and analysis module supports compliance, auditing, lineage analytics, predictive lineage impact assessment, and enforcement actions responsive to anomalous or non-compliant activity. Recordkeeping substrates may include Blockchain-based systems, append-only databases, WORM storage, trusted execution environments (TEEs), secure enclaves, cryptographically verifiable logs, or combinations thereof.

In yet another aspect, the invention provides a combination of verifiable integrity, metadata and imprint tracking, and predictive governance that enables compliance-grade AI lineage. The ability to preserve lineage with cryptographic attestation, tamper-evidence, and detection of unauthorized modification addresses a long-felt but unresolved need for trustworthy AI governance. The system ensures complete lineage coverage across metadata, datasets, models, inference outputs, and imprints, thereby enabling auditability, accountability, transparency, and informed compliance oversight for AI systems deployed across diverse environments.

In one aspect, disclosed is a system for managing artificial intelligence (AI) lineage, comprising: a processor; and a memory storing executable instructions that, when executed by the processor, cause the processor to: capture lineage events associated with at least one of datasets, metadata, models, inference outputs, or imprints thereof; preserve the lineage events as verifiable lineage records using one or more integrity mechanisms comprising at least one of: access control with auditability, detection of unauthorized modification, tamper-evidence, cryptographic attestation, or equivalents; generate a lineage representation linking the verifiable lineage records; and provide governance outputs comprising at least one of compliance, auditing, anomaly detection, predictive analysis, or impact reporting.

In one aspect, the lineage representation supports reverse traversal from inference to contributing datasets and forward traversal for predictive impact analysis. The governance module performs pre-execution gate checks blocking AI workflows when lineage validation fails. Lineage events are committed from federated learning nodes without exposing raw data. Smart contracts enforce lineage validation rules within a distributed ledger. The interface module presents lineage-aware dashboards displaying detected anomalies, confidence drift, or inferred risk levels. The system integrates with MLOps pipelines and emits lineage-based events upon anomaly detection. The system automatically prevents model deployment upon failure of lineage validation. The integrity mechanisms comprise Merkle-encoded fingerprints for all datasets, dataset transforms, and model checkpoints.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a high-level block diagram of the AI lineage system architecture, including user interface, data management, model management, and compliance subsystems.

FIG. 2 illustrates a multi-layered software architecture featuring specialized modules for interface, registration, attestation, tracking, training data lineage, inference traceability, and anomaly remediation.

FIG. 3 shows a multi-layered Blockchain architecture.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term "exemplary" is intended to mean “serving as an example, instance, or illustration.” Any embodiment described as "exemplary" should not be construed as preferred or more advantageous over other embodiments. Similarly, the expression "embodiments of the present invention" does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The scope of the invention will be defined by the claims of any issued patent.

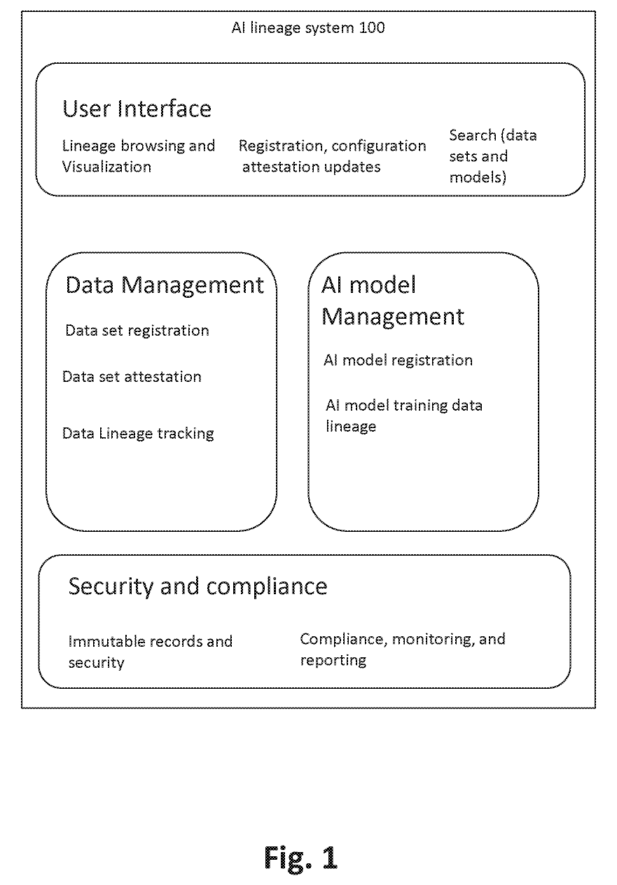

The present invention relates to a verifiable data lineage system designed to address the critical need for transparency, traceability, and auditability in the development, deployment, and operation of artificial intelligence (AI) models. The system provides a structured and reliable method for tracking the complete lineage of datasets, features, model versions, hyperparameters, and inference outputs throughout the AI lifecycle. The architecture is organized into four integrated components: (1) a User Interface, (2) a Data Management component, (3) an AI Model Management component, and (4) a Security and Governance component. It is to be noted that such an architectural layout of the system is for example only and is not limiting the scope of the present invention. FIG. 1 shows a governance and analysis module 140 that supports compliance, auditing, lineage analytics, predictive lineage impact assessment, and enforcement actions responsive to anomalous or non-compliant activity.

The invention provides a comprehensive and intelligent framework for tracking, visualizing, and analyzing the lineage of datasets and AI models using verifiable integrity mechanisms, such as distributed ledgers, Blockchains, or functionally equivalent recordkeeping substrates that provide verifiable integrity. A key feature of the system includes lineage intelligence that detects and alerts users to material changes in the attributes of datasets or AI models. These alerts enable interested parties to receive real-time notifications when modifications occur, permitting rapid detection and remediation of undesired or anomalous changes. All datasets and AI models are attested, registered, and continuously tracked within a verifiable infrastructure, ensuring verifiable integrity, discoverability, and advanced lineage search.

The system enables proactive user notifications triggered by significant lineage events or detected anomalies. In preferred embodiments, the system integrates seamlessly into existing machine learning operations (MLOps) pipelines, thereby enhancing governance, ownership, visibility, and operational responsibility across AI workflows.

The system interoperates with hyperscalers and third-party AI development platforms through a robust application programming interface (API) layer. A consumer-facing analytical and configuration management plane is included, together with a suite of lineage-aware machine learning intelligences. This combination forms a unified platform for smart lineage experiences, significantly improving trust, transparency, and explainability of AI inferences.

In certain implementations, lineage events explicitly include provenance from (i) syndicated/licensed providers, (ii) enterprise source systems, and (iii) platform-native or ingested data, thereby recording pre-ingest, ingest, and post-ingest lineage uniformly.

Referring now to FIG. 1, the system architecture comprises four primary components: the User Interface, the Data Management component, the AI Model Management component, and the Security and Governance component.

The User Interface component provides intuitive tools for lineage browsing and visualization, enhancing system usability and user accessibility. It supports seamless dataset and model registration, configuration updates, and attestation through user-friendly forms and dashboards. Additionally, the interface enables advanced search capabilities across datasets and AI models, thereby improving operational efficiency and user interaction.

The Data Management component enables robust dataset registration, ensuring traceability from the point of dataset inception through all stages of usage and transformation. This component incorporates attestation mechanisms to verify authenticity and reliability prior to model development. The system captures comprehensive dataset lineage using secure hashing techniques such as SHA-256, resulting in lineage records having verifiable integrity.

The AI Model Management component supports the registration and tracking of AI models and their associated metadata, including hyperparameters, model architectures, and version history. This component maintains detailed records of model iterations and changes over time. It further documents the lineage of training datasets used for model development, thereby enabling full reproducibility and transparency. Additionally, it incorporates advanced inference traceability mechanisms that capture and record outputs, contributing to thorough audit trails and interpretability of model behavior. The Data Management component and AI Model Management component are also referred to as record keeping module 136.

The Security and governance component provides for preserved lineage events that are secured using recordkeeping substrates that supports verifiable integrity. This component is designed to support regulatory and governance requirements by integrating compliance monitoring and reporting capabilities that align with existing data privacy and AI regulation frameworks, including the General Data Protection Regulation (GDPR), the California Consumer Privacy Act (CCPA), and the European Union Artificial Intelligence Act (AI Act). Automated real-time monitoring is also included, generating alerts and notifications upon detection of compliance deviations or anomalies.

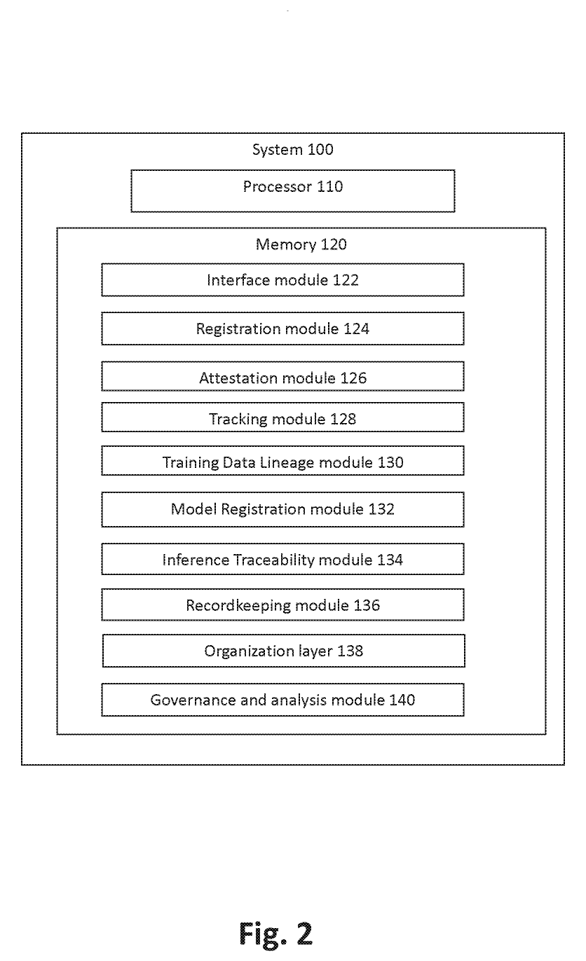

Referring now to FIG. 2, a block diagram illustrates the architecture of the system 100. The system 100 includes a processor 110 and a memory 120 operably coupled to the processor 110. The processor 110 may include any suitable logic circuitry capable of executing instructions retrieved from memory 120. The memory 120 may include one or more non-transitory memory devices, such as DRAM or flash memory, configured to store executable instructions and application data. The memory 120 includes a plurality of software modules for executing steps of the disclosed methodology, including but not limited to: an Interface Module 122, a Registration Module 124, an Attestation Module 126, and a Tracking Module 128.

The functions described herein may be performed by a single computing system or by cooperating modules or services operating under unified control or contractual orchestration. The system maintains lineage continuity across systems, models, services, agents, or platforms.

From a technical implementation standpoint, the system utilizes recordkeeping substrates that support integrity verification (e.g., distributed ledger, append-only log, WORM storage, trusted execution environment, secure enclave, or cryptographically verifiable log) to record and manage lineage of datasets and AI models. Each dataset and model instance is accompanied by metadata and a historical log of transformations, modifications, and derivations, forming a verifiable integrity audit trail. This ensures long-term data integrity, supports retrospective analysis, and facilitates regulatory or forensic investigations.

The system generates cryptographic hashes for data elements, AI model versions, and lineage events to ensure verifiable data integrity. For example, Secure Hash Algorithm 256 (SHA-256) and Merkle tree hashing techniques may be used to represent the state and content of training data batches, dataset versions, and inference payloads. These hash values are stored on a recordkeeping substrate, thereby securing the associated data. Any alteration to the underlying data would result in a different hash value, thereby making even the slightest unauthorized change detectable.

### Dataset Management

Technical Process: The system comprises a Registration Module, an Attestation Module, and a Tracking Module. When executed by the processor, these modules facilitate the registration, verification, and tracking of datasets. The Registration Module registers datasets into the system by computing and recording cryptographic hash values for each dataset on the recordkeeping substrate, such as a distributed ledger or append-only log. Each storage entry includes structured metadata comprising details such as: Event type (e.g., training, inference, correction, anomaly), Timestamp, Dataset ID and hash, Model ID and version hash, originating system or service, Inference output or telemetry summary, and Correction rule (if triggered). This structured metadata enables traceability and intelligent querying of lineage records.

The Attestation Module verifies the integrity and authenticity of datasets using cryptographic techniques. Any tampering or unauthorized modification becomes evident due to the resulting hash value mismatch.

The Tracking Module logs all modifications applied to datasets, such as data cleaning, augmentation, or merging. Each modification is treated as a transaction and recorded on the recordkeeping substrate thereby generating a complete lineage trail.

### AI Model Management

The system further manages the complete lifecycle of AI models through modules including a Training Data Lineage Module 130, a Model Registration Module 132, and an Inference Traceability Module 134.

The Training Data Lineage Module records the specific datasets, including versions and subsets, used in training each AI model. This linkage provides a direct mapping between models and their training data, supporting reproducibility and auditability.

The Model Registration Module registers AI models with their associated metadata such as training parameters, algorithms used, and performance metrics. All such information is securely committed to the recordkeeping substrate.

The Inference Traceability Module tags each AI inference with corresponding lineage information. This includes links to the datasets and model versions that contributed to the output, enabling users to trace back the exact origin of an AI-generated result.

### Lineage Interface

Technical Process: The system provides a user-friendly interface that allows for dynamic exploration of dataset and model lineage. Through this interface, users can search, filter, and visualize the historical progression of datasets, data transformations, model training iterations, and inference events. The interface also surfaces past lineage-related events—such as detected anomalies or triggered rules—for user awareness and decision-making.

Query Mechanism: The system enables users to perform complex, multi-criteria queries to discover relationships between datasets and AI models. This facilitates the understanding of dependencies, supports data quality analysis, and informs decisions regarding model reliability.

### Security and Governance

Technical Process: The system incorporates multiple mechanisms to ensure robust security and compliance throughout the AI lifecycle:

Records: All records are committed to a recordkeeping substrate, ensuring verifiable integrity, which supports secure and verifiable audit trails. It is to be noted that Blockchain-based systems are only described as embodiments, and the invention may encompass different verifiable record keeping mechanisms, such as Append-Only Logs, Write-Once-Read-Many (WORM) Storage, secure enclaves, Trusted Execution Environments (TEEs), or Cryptographically Verifiable Logs.

Access Control: The system employs both attribute-based access control (ABAC) and role-based access control (RBAC) models to manage and restrict user permissions according to organizational policies and data sensitivity.

Governance Monitoring: The system includes automated governance monitoring and reporting functions that align with global data governance and regulatory requirements, including GDPR, CCPA, and the EU AI Act.

### Dynamic Anomaly Detection and Correction

Technical Process: The system incorporates an AI-driven dynamic anomaly detection mechanism that identifies and corrects anomalies or inconsistencies in data lineage in real-time. This is achieved through advanced machine learning algorithms trained on historical data lineage patterns. When an anomaly is detected, a correction algorithm using predefined rules and patterns is activated to automatically rectify the inconsistency. This dynamic correction process involves real-time data validation and correction using feedback loops from the anomaly detection models, ensuring a higher level of data integrity and reliability.

### Detection Process

The system continuously monitors data and model lineage records using machine learning algorithms. These algorithms compare real-time lineage data against baseline patterns and thresholds. Upon detecting anomalies, the system categorizes them by severity and generates alerts accordingly.

### Value of Anomaly Detection

Enhanced Data and Model Integrity: Ensuring data lineage and model records are accurate and consistent enhances overall data integrity.

Real-Time Response: Real-time detection minimizes the window of vulnerability, allowing immediate action to prevent the propagation of errors.

Trust and Transparency: Automated detection mechanisms build trust in the data and model lineage system by promptly identifying and addressing inconsistencies.

Regulatory Compliance: Helps meet regulatory compliance by maintaining accurate and reliable lineage records.

Operational Efficiency: Automating the detection and correction of anomalies reduces the need for manual intervention.

Improved Decision-Making: Reliable lineage information supports better decision-making by providing accurate insights into data transformations and model training processes.

### Remediation (Correction Process)

For detected anomalies, the system activates a correction algorithm. The correction algorithm applies predefined rules and patterns to rectify the inconsistency. Corrections are logged as new transactions on the verifiable integrity recordkeeping substrate to maintain a transparent and auditable record. Feedback loops are established to continuously improve the anomaly detection models. Corrected anomalies and their resolutions are used as additional training data to enhance the accuracy and effectiveness of the detection models.

The correction algorithm is AI-governed and continuously monitors lineage events such as data ingestion, model training, inference generation, and performance drift. Anomalies are identified by comparing real-time telemetry to historical benchmarks. Example scenarios include: a sudden drop in model confidence levels; a data fingerprint hash mismatch with the attested source, and performance deviation beyond domain-specific thresholds (e.g., “confidence drift >20% across 10 inference cycles triggers rollback”). Upon detecting such deviations, the system can roll back to a previously attested model; quarantine suspect datasets; revalidate inference workflows; and alert human reviewers for oversight.

### Multi-Layered Blockchain for Enhanced Security and Scalability

Technical Process: In certain implementations, a multi-layered Blockchain approach is utilized where different layers handle various aspects of data lineage and model tracking. For instance, one layer manages data integrity, another handles data lineage, and a third ensures compliance and auditing. Each layer is optimized for its specific function, improving security, scalability, and performance. This separation of concerns within the Blockchain architecture ensures that the system can scale efficiently and maintain high security standards.

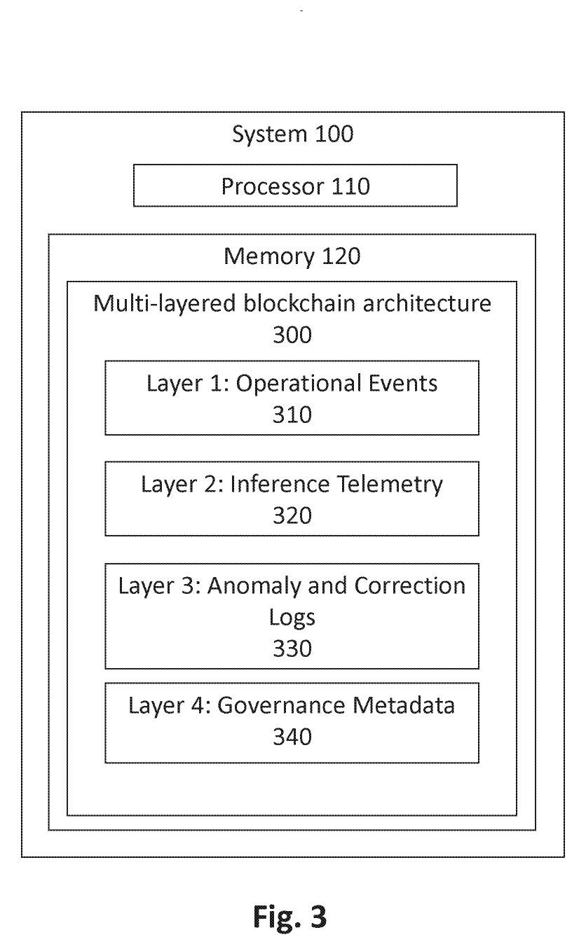

Referring to FIG. 3, the multi-layered Blockchain 300 approach refers to a design that uses distinct Blockchain chains or segments to store categorized information about the AI lifecycle, rather than a monolithic, one-size-fits-all ledger. Each layer captures a different class of lineage-critical event:

Layer 1 (Operational Events) 310: Tracks model versioning, data set usage, deployment timestamps, and model ownership.

Layer 2 (Inference Telemetry) 320: Records inference output, model confidence scores, and metadata such as latency or failure flags.

Layer 3 (Anomaly and Correction Logs) 330: Documents when anomalies are detected and how the system responded, including which corrective rule was triggered.

Layer 4 (Governance Metadata) 340: Stores compliance certifications, audit outcomes, and policy validations.

These layers can be implemented in logically separated chains or as indexed channels within a permissioned Blockchain. This structure enhances scalability, simplifies querying, and ensures different types of events can be governed according to their specific compliance needs.

### Federated Learning Telemetry and Reasoning System Technical Process

The system integrates with existing federated learning frameworks, such as frameworks analogous to commercial federated-learning frameworks (e.g., those providing APIs for federated training/inference coordination), to provide comprehensive tracking and visibility of federated learning processes. It allows users to specify the federated relationships between models, their data sources, and training environments. The system automatically receives telemetry data from these models for each inference, adjustment, training session, and federated reintegration at the source model. This ensures detailed visibility, tracking, and attestation of the entire federated learning lifecycle.

### Integration with Federated Learning Frameworks

Framework Support: The system is designed to work with federated learning frameworks like frameworks analogous to commercial federated-learning frameworks (e.g., those providing APIs for federated training/inference coordination). It does not replicate the functionalities of these frameworks but complements them by adding robust tracking and reasoning capabilities.

API Interaction: The system provides APIs for federated learning frameworks to log training, inference, and adjustment data.

### Telemetry Data Collection

Automated Telemetry: The system automatically collects telemetry data from federated models, capturing details of each inference, weight adjustment, training session, and reintegration into the source model.

Data Logging: All telemetry data is logged on a suitable record-keeping mechanism that ensures verifiable integrity, ensuring immutability and transparency. This includes metadata such as the time of inference, the data source, and the specific model version used.

### Reasoning Over Telemetry

Anomaly Detection: The system applies machine learning algorithms to the collected telemetry data to detect anomalies. Anomalies can include unexpected changes in model weights, unusual inference patterns, or deviations in training results.

Alerts and Alarms: When an anomaly is detected, the system raises alerts or alarms. These alerts are logged and can be sent to relevant stakeholders through various channels (e.g., email, SMS, dashboards).

### Data Visualization

Visual Lineage Tracking: The system provides a user-friendly interface for visualizing the lineage of federated learning models and their contributing data sets. This includes details of training sessions, inferences, adjustments, and detected anomalies.

Interactive Dashboards: Users can interact with dashboards to explore the telemetry data, filter by various criteria, and view detailed reports.

### INTEGRATION WITH MLOPS PIPELINES

Event Issuance: The system issues events based on the telemetry data and detected anomalies. These events can be consumed by existing MLOps pipelines for further processing.

In certain embodiments, the system provides an application programming interface (API) that enables interaction with federated learning platforms. For example, federated learning platforms—such as those analogous to Amazon SageMaker or TensorFlow Federated—may query the system through the API to determine whether a federated learning operation should proceed based on the most recent telemetry data and anomaly reports. The API supports pre-execution validation in which federated training or inference is conditionally authorized only if lineage, integrity, and compliance requirements are satisfied. If the system indicates the presence of material anomalies, non-attested datasets, or policy violations, the federated learning workflow may be blocked, deferred, or routed for corrective action prior to continuation.

### PREDICTIVE IMPACT ANALYSIS

Predictive impact analysis computes prospective downstream effects of a proposed change to datasets, features, or model parameters by traversing the lineage representation from the candidate change node forward to dependent artifacts, estimating impact using dependency types (e.g., training, transformation, feature derivation) and historical sensitivity metrics, and generating an impact report with affected models, confidence bands, and recommended remediation (e.g., retraining).

### Policy Enforcement:

Policy enforcement includes: (i) pre-execution gate checks that block pipeline runs when lineage validation fails (e.g., imprint mismatch, missing attestation); (ii) post-execution attestation that signs result envelopes and publishes verification receipts; and (iii) workflow approvals that require human sign-off when impact analysis exceeds thresholds (e.g., ‘>10% of production models affected’).

The disclosed AI Lineage system delivers significant value to organizations, governments, and industry verticals requiring detailed AI model explanations, transparency, and attestation. The disclosed AI Lineage system offers several advantages including - Enhanced Transparency and Explainability: Organizations gain a robust ability to articulate clearly how AI model decisions are derived, significantly improving trust and regulatory compliance; Comprehensive Compliance and Regulatory Alignment: Governments and regulatory bodies benefit from improved visibility into AI processes, facilitating straightforward adherence to evolving compliance mandates such as GDPR, CCPA, and the EU AI Act; and Improved Decision-making Integrity: Industry verticals such as finance, healthcare, defense, and insurance can reliably verify the veracity of datasets and the accuracy of AI model inferences, enhancing overall operational integrity.

The disclosed AI Lineage system addresses critical limitations inherent in existing fragmented platforms by integrating intuitive user interfaces, comprehensive lineage tracking, robust model management, and advanced security and compliance features. Unlike current solutions that often provide incomplete or disconnected lineage capabilities, the disclosed system provides an integrated, unified, and auditable lineage infrastructure, significantly enhancing user efficiency and regulatory compliance capabilities.

By way of example, in one enterprise evaluation, the system demonstrated several improvements and benefits including auditing cycle time was reduced by 40%, lineage tracking accuracy was improved by 60%, and regulatory reporting efficiency increased by up to 50%. Moreover, by employing SHA-256 cryptographic hashing and verifiable integrity-inspired mechanisms, the system robustly guarantees data security and integrity. The system explicitly aligns with essential regulatory frameworks such as GDPR, CCPA, and the EU AI Act, ensuring sustained compliance and future-proof relevance.

In certain implementations, disclosed is a system comprising a processor executing a plurality of modules stored in memory. These include Interface Module which allows interaction via web dashboards and APIs; Registration and Attestation Modules which handle cryptographic dataset/model registration and validation; Tracking and Lineage Modules which monitor dataset transformations, model training, and inference operations, generating cryptographic hashes; Anomaly Detection and Correction Engine which monitors event streams, compares real-time metrics against thresholds, and triggers rule-based remediation (e.g., model rollback, dataset quarantine); and Smart Contract Engine which executes compliance policies on-chain (e.g., inference confidence thresholds, data fingerprint verification).

In certain implementations, the disclosed system includes Federated Learning Support. Each participant node contributes local lineage entries hashed and committed to the Blockchain without exposing raw data, ensuring privacy-compliant traceability.

In certain implementations, the disclosed system includes a Blockchain Infrastructure which includes multiple logical layers including Operational Events Layer which tracks model training, data ingestion, deployment timestamps; Inference Telemetry Layer which logs inference results, confidence scores, latency; anomaly and Correction Layer which stores deviation events and applied remediation logic; Governance and Certification Layer which maintains auditor stamps, lineage attestations, and cross-jurisdictional compliance certifications.

The disclosed system specifically provides for improved security & compliance. The system can implement access control which includes Role-Based Access Control (RBAC) and Attribute-Based Access Control (ABAC). Regulatory monitoring adheres to GDPR, CCPA, HIPAA, and the EU AI Act. Logs, with verifiable integrity, are stored in a recordkeeping substrate, enabling forensic traceability and external audit.

The disclosed system delivers a novel, scalable, and compliant solution to AI lineage management, integrating verifiable record keeping, anomaly correction, federated traceability, and automated governance enforcement. The disclosed system addresses a pressing industry need by enabling verifiable trust and transparency in AI pipelines, especially across multi-party, regulated environments. The record keeping mechanism may include Blockchain, distributed ledgers, append-only logs, WORM storage, secure enclaves, TEEs, or cryptographically verifiable logs.

In certain implementations, the disclosed method includes structuring lineage events as attested envelopes comprising consistent identifiers and metadata; organizing the attested envelopes into a lineage representation configured to support efficient traversal from an inference event back to the contributing datasets and models; and providing predictive impact analysis that enables evaluation of proposed changes to data, features, or model parameters without requiring exhaustive ad hoc investigation. The predictive impact analysis may traverse the lineage representation forward from a candidate change node to identify dependent artifacts and may estimate downstream effects using dependency types, historical sensitivity metrics, or confidence thresholds.

In certain implementations, the disclosed system can be deployed across a wide array of computing devices and environments, including cloud platforms, edge devices, on-premises servers, and hybrid infrastructures. Multiple implementations of the disclosed system may interoperate, and lineage continuity may be maintained across them. For example, an output generated by a first AI system may be incorporated as training data for a second AI system, with both systems linked through the lineage records and the organization layer. The organization layer 138 is configured to represent relationships among the verifiable lineage records as a lineage representation comprising at least one of: a graph structure, relational schema, key-value index, JSON or document store, or columnar mapping. Likewise, an inference produced by a first model may be used as an input feature for training a second model, such that dependency relationships among models, datasets, and inference artifacts remain preserved and traceable across distributed systems.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for managing artificial intelligence (AI) lineage, comprising:
a processor; and
a memory operably coupled to the processor, the memory storing executable instructions that, when executed by the processor, cause the processor to implement operations, the memory comprising:
a recordkeeping module configured to:
capture and preserve lineage events associated with at least one of datasets, metadata, models, inference outputs, or content-addressable imprints thereof, and
maintain verifiable lineage records by employing one or more integrity mechanisms comprising at least one of: access control with auditability, detection of unauthorized modification, tamper-evidence, or cryptographic attestation;
an organization layer configured to:
represent relationships among the verifiable lineage records as a lineage representation comprising at least one of: a graph structure, relational schema, key-value index, JSON or document store, or columnar mapping; and
a governance and analysis module configured to:
facilitate compliance, auditing, or analysis based on the verifiable lineage records.

2. The system of claim 1, wherein the recordkeeping module comprises a distributed ledger.

3. The system of claim 1, wherein the recordkeeping module comprises an append-only data store or write-once-read-many (WORM) storage.

4. The system of claim 1, wherein the recordkeeping module comprises a trusted execution environment or secure enclave configured to emit attested logs.

5. The system of claim 1, wherein the integrity mechanisms comprise digital signatures, hash chains, Merkle structures, or content-addressable identifiers.

6. The system of claim 1, further comprising an interface module configured to retrieve lineage information through one or more of: visualizations, queries, reports, or application programming interfaces (APIs).

7. The system of claim 1, wherein the governance and analysis module is configured to enforce policies using smart contracts, rule engines, policy-as-code frameworks, or workflow approvals.

8. The system of claim 1, wherein the lineage events comprise:
metadata associated with datasets, models, or inference outputs; and
imprints comprising cryptographic hashes, digital fingerprints, or equivalent integrity representations.

9. The system of claim 8, wherein the lineage events further comprise provenance references to syndicated or licensed data providers and enterprise source systems captured prior to platform ingestion

10. The system of claim 1, wherein the recordkeeping module persists attested envelopes comprising identifiers, timestamps, provenance pointers, policy tags, and signatures or attestation evidence.

11. The system of claim 1, wherein the recordkeeping module comprises a plurality of logically separated blockchain layers including:
a first layer storing operational events;
a second layer storing inference telemetry;
a third layer storing anomaly and correction logs; and
a fourth layer storing governance metadata;
wherein the blockchain layers collectively provide tamper-evident and integrity-verifiable lineage across the AI lifecycle.

12. The system of claim 1, wherein the system is configured to manage artificial intelligence (AI) lineage across multiple devices, wherein the lineage representation links:
an inference generated by a first AI model executing on a first device or service to a dataset used to train a second AI model executing on a second device or service,
wherein the first and second AI models exchange lineage evidence through the lineage representation.

13. A computer-implemented method for managing artificial intelligence (AI) lineage, comprising:
capturing lineage events;
preserving the lineage events using verifiable integrity mechanisms comprising at least one of access control with auditability, detection of unauthorized modification, tamper-evidence, or cryptographic attestation;
constructing a lineage representation linking the lineage events; and
producing governance outputs comprising at least one of compliance reports, audit trails, anomaly detection, predictive impact analysis, or remediation instructions.

14. The method of claim 13, further comprising structuring lineage events as attested envelopes comprising identifiers, timestamps, policy tags, provenance pointers, and digital signatures.

15. The method of claim 13, further comprising relating datasets, metadata, models, parameters, and inference artifacts within the lineage representation.

16. The method of claim 13, wherein producing governance outputs comprises generating regulator-ready audit packages.

17. The method of claim 13, wherein the lineage events comprise provenance references to syndicated or licensed data providers and enterprise source systems captured prior to platform ingestion.

18. The method of claim 13, wherein recordkeeping functions, governance functions, and interface functions are performed by cooperating modules or services under unified control.

19. The method of claim 13, wherein the lineage representation comprises at least one of a graph structure, relational schema, key-value index, JSON or document store, columnar mapping, or equivalent.

20. The method of claim 13, further comprising:
computing a content-addressable imprint for each persisted dataset or model;
storing the imprint in a signed or append-only record; and
validating integrity by recomputing and comparing the imprint to the stored record, and
generating a tamper-detection alert upon mismatch.

21. The method of claim 13, wherein the governance outputs satisfy data-provenance or auditability requirements under financial, healthcare, or privacy regulations.

22. The method of claim 13, wherein the lineage records link inferences generated by a first AI system to training datasets utilized by a second AI system, the first and second AI systems comprising distinct models, services, or agents that exchange outputs and lineage evidence via the organization layer.

23. The method of claim 13, wherein the method further comprises maintaining verifiable integrity even if stored on a mutable infrastructure.

24. A non-transitory computer-readable medium storing instructions that, when executed by a processor, cause the processor to perform operations comprising:
capture lineage events associated with at least one of datasets, metadata, models, inference outputs, or imprints thereof;
preserve the lineage events as verifiable lineage records using one or more integrity mechanisms comprising at least one of: access control with auditability, detection of unauthorized modification, tamper-evidence, cryptographic attestation, or equivalents;
generate a lineage representation linking the verifiable lineage records; and
provide governance outputs comprising at least one of compliance, auditing, anomaly detection, predictive analysis, or impact reporting.
